(19) United States
(12) Patent Application Publication
(10) Pub. No.: US 2020/0052733 A1
(43) Pub. Date: Feb. 13, 2020

(54) MOBILE PHONE CASE

(71) Applicant: FRAMEBY CO., LTD., Seoul (KR)

(72) Inventor: Gi Ho Yang, Yongin-si (KR)

(73) Assignee: FRAMEBY CO., LTD., Seoul (KR)

(21) Appl. No.: 16/491,311

(22) PCT Filed: Oct. 26, 2017
(86) PCT No.: PCT/KR2017/011921

§ 371 Date: Sep. 5, 2019

(30) Foreign Application Priority Data
Mar. 21, 2017 (KR) 10-2017-0035478

(51) Int. Cl. H04B 1/3888; A45C 11/18

(52) U.S. Cl. CPC H04B 1/3888; A45C 11/182

(57) ABSTRACT

The present invention relates to a mobile phone case that protects a mobile phone from external shocks by surrounding the same except for a screen of the mobile phone, minimises the thickness of a rear surface of the mobile phone case, accommodates a card (credit card, transport pass, debit card and the like) in the case so that the card also serves as a case, allows the card mounted inside the case to be taken out easily using one hand, and at the same time can prevent an error from occurring in advance by blocking electromagnetic waves generated from the mobile phone when using a transport pass. To this end, the present invention is characterised by forming an opening part (11) having a size smaller than a total height (s′) of a card (20) on the rear surface of the mobile phone case (10), forming an extension part (12) having a width that allows the card (20) to be inserted in an upper portion of the opening part (11), forming a protrusion part (14) in a lower portion of the extension part (12) so that a rail (13) for accommodating both side edges of the card (20) is formed, forming an inclined surface (16) onto which an upper portion of the card (20) inserted along the rails (13) is laid at a slant in an upper portion of the extension part (12), and thereby the upper portion of the card (20) is laid at a slant onto the inclined surface (16) and the card (20) is accommodated in the opening part (11) and the inclined surface (16) so as to completely close the opening part (11) when the card (20) is inserted along the rails (13) through the extension part (12).

### BACKGROUND OF THE INVENTION

### Technical Field

The present invention relates to a mobile phone case that protects a mobile phone from external shock by wrapping the rest of the mobile phone except for the screen, buttons, and camera of the mobile phone and, more specifically, to a mobile phone case, which can minimize the thickness of the rear surface of the mobile phone case while storing a card (a credit card, a transportation card, a debit card, etc.) in the case so that while the card acts as the case, the card stored inside the case can be easily withdrawn from the case with one hand and can block the electromagnetic waves generated from a mobile phone so as to prevent an error from occurring at the time of using a transport pass.

### Background Art

In general, due to the development of IT, while carrying a mobile phone or a smart phone with good portability and functionality, people have enjoyed various benefits such as the Internet and mobile communications as well as telephone calls.

In addition, a mobile phone or a smart phone performs various functions such as a digital camera, a media player, and a digital storage device, as well as a simple call function, and thus many expensive products are provided. Therefore, users are increasingly using cases to protect the appearance of their mobile phones from scratches or external shocks.

These mobile phones are portable and can be connected to the outside anytime, anywhere, so that everyone of all ages is carrying a mobile phone all the time.

Conventional credit cards, transportation cards, debit cards, building access cards, etc. (hereinafter, referred to as “card”) each has its own function, so that a user needs to carry a plurality of cards and thus needs a wallet.

However, due to the development of technology and for the convenience of users, card companies provide functions to enjoy various benefits with a single card. Accordingly, a user may use a small card wallet, which makes the card more convenient to carry. Recently, a mobile phone case has been developed and released so that everyone can carry a card inside the case of a mobile phone that is always carried by everyone.

That is, a mobile phone case for allowing convenient storage of a card has been developed and registered under Korean Patent No. 1288042 (registered on 15 Jul. 2013).

FIG. 1 is a perspective view showing a conventional mobile phone case, and FIG. 2a and FIG. 2b show longitudinal sectional views showing the conventional mobile phone case, in which a mobile phone case 100 capable of storing a card includes a rear surface part 110, which serves to encase and protect the bottom surface of a mobile phone, and a side surface part 120, which encases the mobile phone so as to fix the mobile phone case 100 in close contact with the mobile phone.

The rear surface part 110 includes a holding projection 111, a stopper protrusion part 113, and a card withdrawal groove 114, and the side surface part 120 includes a card storage groove 130.

Referring to FIG. 2a, the holding projection 111 is formed on the inner bottom surface of the rear surface part 110, wherein the holding projection 111 is made of soft silicone or thermoplastic polyurethane TPU and accordingly friction force acts between the holding projection 111 and a card 200 such that the holding projection 111 serves to support the card 200 and to prevent the card 200 from falling out of the card storage groove 130.

Therefore, when the card 200 is pushed against and inserted into the card storage groove 130 of the mobile phone case 100, since the card 200 is caught by the stopper protrusion part 113 so as to be restricted in insertion and is simultaneously pressed by the holding projection 111 such that the storing of the card 200 is completed, as shown in FIG. 2b, the card 200 can be carried along with the mobile phone 300.

In the case where a user wants to remove and use the card 200 as necessary while carrying the card 200 with the mobile phone 300 as above, if the user places a finger on a card withdrawal groove 114 formed on the rear surface part 110 of the mobile phone case 100, presses the card 200, and then pushes the card 200 towards the card storage groove 130 side, then a part of the card 200 comes out of the card storage groove 130 such that the user can grip and withdraw the card 200.

### PRIOR ART DOCUMENTS

(Patent Documents 0001) Korean Reg. Patent Publication No. 10-1288042 (registered on 15 Jul. 2013)

(Patent Document 0002) Korean Reg. Utility Model Publication No. 20-469053 (registered on 9 Sep. 2013)

(Patent Document 0003) Korean Reg. Utility Model Publication No. 20-478908 (registered on 24 Nov. 2015)

### DETAILED DESCRIPTION OF THE INVENTION

### Technical Problem

However, these conventional mobile phone cases have various problems as follows.

First, the mobile phone case gives a clunky feel during carrying since the rear surface part of the mobile phone case becomes thick due to the card storage space formed inside the mobile phone case, and expensive silicon consumption increases as the material of the mobile phone case, resulting in the increase of the production cost.

Second, the separate stopper protrusion for preventing the card from being removed from the mobile phone case and the holding projection for controlling the insertion amount of the card must be respectively adhered and fixed to the inner surface of the rear surface part of the mobile phone case, thereby increasing man hours, and the repeated use of the mobile phone case may cause the stopper protrusion or holding projection to fall off the rear surface part and lose own function.

Third, the magnet containing the information of the card may be damaged due to repeated friction with the mobile phone case or the rear surface of the mobile phone during long-term use since the card is inserted into or withdrawn from the card storage groove by pushing or pulling.

Fourth, in order to withdraw the card stored in the card storage groove, while holding the mobile phone with one hand, the card has to be pressed through the card withdrawal groove formed in the rear surface part with the fingers of the other hand, pushed toward the card storage groove side, and gripped to be withdrawn. Therefore, the user must use both hands and thus the withdrawal of the card is cumbersome.

Fifth, in the case where a transport pass is stored in the mobile phone case, since an error occurs due to the influence of electromagnetic waves generated in the mobile phone, the transport pass has to be taken out of the mobile phone case whenever the user wants to use the transport pass and then has to be stored again after use, thereby involving inconvenience of use.

The present invention has been derived in an effort to solve the above-mentioned problems and has an objective to provide a mobile phone case, in which an opening part is formed in the rear surface of the mobile phone case and has a size smaller than the total height of a card, and an inclined surface is formed at the upper portion of the opening part so as to allow the upper portion of the card to be placed on the inclined surface such that the card is completely received and the opening part is completely closed, and then to allow the card stored in the mobile phone case to be easily withdrawn with one hand.

The present invention has another objective to prevent an error from occurring due to the electromagnetic waves at the time of using a transport pass by adhering and fixing an electromagnetic wave shield member to the rear surface of the mobile phone case instead of taking out the transport pass from the mobile phone case.

The present invention has still another objective to prevent the card, which is stored in the opening part, from falling off and to allow the user to audibly recognize that the storage of the card is finished, by forming the projections to face each other on both sides of the lower portion of the rails, which are perpendicularly formed at both sides of the opening part, so as to support the side surfaces of the stored card and thus to prevent damage to the magnet of the stored card.

### Technical Solution

According to one aspect of the present invention in order to achieve the above objectives, there is provided a mobile phone case including an opening part formed in the rear surface of the mobile phone case and having a size smaller than the total height of a card, an extension part formed at an upper portion of the opening part and having a width that allows the card to be inserted, protrusion parts formed at a lower portion of the extension part so that rails for accommodating both side edges of the card is formed, and an inclined surface formed at an upper portion of the extension part so that the upper portion of the card inserted along the rails is laid at a slant on the inclined surface, wherein if the card is inserted along the rails through the extension part, the upper portion of the card is laid at a slant onto the inclined surface and the card is accommodated in the opening part and the inclined surface so as to completely close the opening part.

### Effects of the Invention

The present invention has several advantages over the prior art as follows.

First, the upper portion of the card stored in the mobile phone case is placed on the inclined surface so as to be lifted such that if the user holds the mobile phone with one hand and simply pushes the card upwards with the thumb of the hand holding the mobile phone, then the card having the upper portion lifted by the inclined surface is easily withdrawn from the mobile phone case. Therefore, the withdrawal of the card becomes convenient.

Second, the card stored in the mobile phone case completely closes the opening part and serves as a part of the case such that the rear surface part of the case can be minimized while safely protecting a mobile phone and the expensive material consumption can be reduced during the forming of the mobile phone case, resulting in saving the manufacturing cost.

Third, when the electromagnetic wave shield card is fixed to the rectangular concave groove formed on the rear surface of the mobile phone case, the transport pass is not affected by the electromagnetic waves when the transport pass is used even without removing the transport pass from the mobile phone case, thereby providing convenience for the use of the transport pass.

Fourth, the projections are formed at the lower portions of the rails so as to support both side surfaces of the card such that a click sound is audibly heard at the time of finishing the storage of the card in the mobile phone case and thus the user does not have to visually identify the stored state of the card.

Fifth, as the card is stored in the mobile phone case, the card completely closes the opening part such that the characters or patterns appearing on the surface of the card can be expressed extending to the mobile phone case and thus the mobile phone case also serves as an ornament when fashion-conscious teenagers carry mobile phones.

### BRIEF DESCRIPTION OF DRAWINGS

FIG. 1 is a perspective view showing a conventional mobile phone case,

FIG. 2a and FIG. 2b show longitudinal sectional views showing the conventional mobile phone case,

FIG. 3 is an exploded perspective view showing a mobile phone case of the present invention,

FIG. 4 is a longitudinal sectional view showing an assembly state of FIG. 3,

FIG. 5 is a longitudinal sectional view showing a state, in which a card is stored in the mobile phone case of the present invention such that the card completely closes an opening part formed in the mobile phone case,

FIG. 6 shows a state, in which both sides of the card are tightly inserted into protrusions formed on the lower portion of rails, and

FIG. 7a and FIG. 7b are rear views showing of the mobile phone case of the present invention in a state, in which characters or patterns are formed repeatedly in succession with a card.

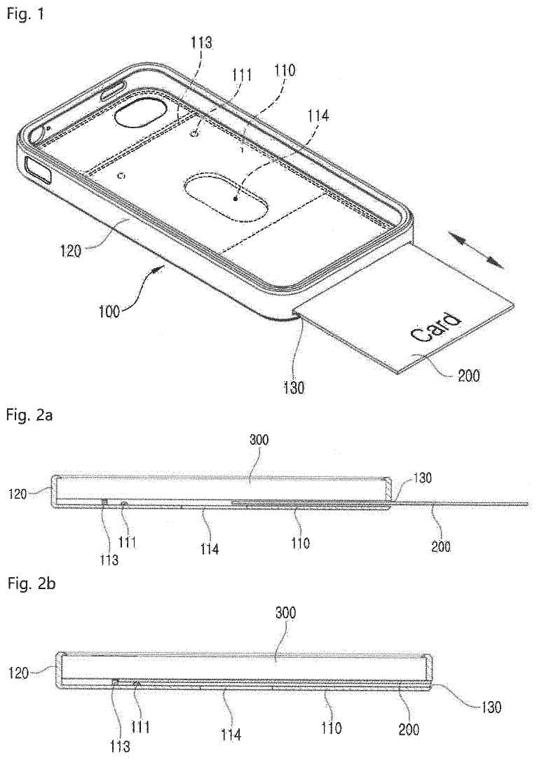

### BEST MODE FOR CARRYING OUT THE INVENTION

Hereinafter, embodiments of the present invention will be described in detail with reference to the accompanying drawings such that a person skilled in the art could easily carry out the present invention. The present invention may be embodied in many different forms and is not limited to the embodiments described herein. It is noted that the drawings are schematic and are not drawn to scale. The relative dimensions and ratios of the parts in the drawings are shown exaggerated or reduced in size for clarity and convenience in the drawings, and any dimensions are merely illustrative and not restrictive. In addition, the same reference numerals are used to refer to similar features in the same structure, element or part shown in more than one figure.

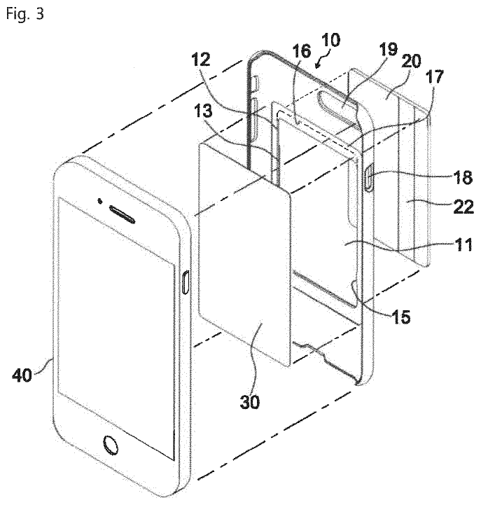

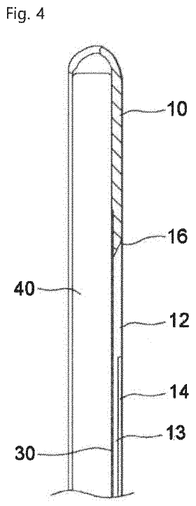

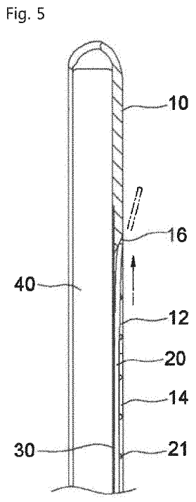

FIG. 3 is an exploded perspective view showing a mobile phone case of the present invention, FIG. 4 is a longitudinal sectional view showing an assembly state of FIG. 3, and FIG. 5 is a longitudinal sectional view showing a state, in which a card is stored in the mobile phone case of the present invention such that the card completely closes an opening part formed in the mobile phone case.

The present invention includes an opening part 11 formed in the rear surface of a mobile phone case 10 and having a size h′ smaller than the total height h of a card 20, an extension part 12 formed at the upper portion of the opening part 11 and having a width b′>b that allows the card 20 to be inserted, and protrusion parts 14 formed at the lower portion of the extension part 12 so that rails 13 for accommodating the both side edges of the card 20 is formed.

The height t of the protrusion part 14 is formed higher than the height of an embossing 21 height of the card 20, which is accommodated along the rails 13 and closes the opening part 11.

This is to prevent the embossing 21 formed on the card 20 from coming into contact with the surface of a desk or the like and damaging the desk even if the mobile phone case 10 is placed on the surface of the desk or the like while the card 20 is stored along the rails 13 formed at both sides of the opening part 11 and closes the opening part 11.

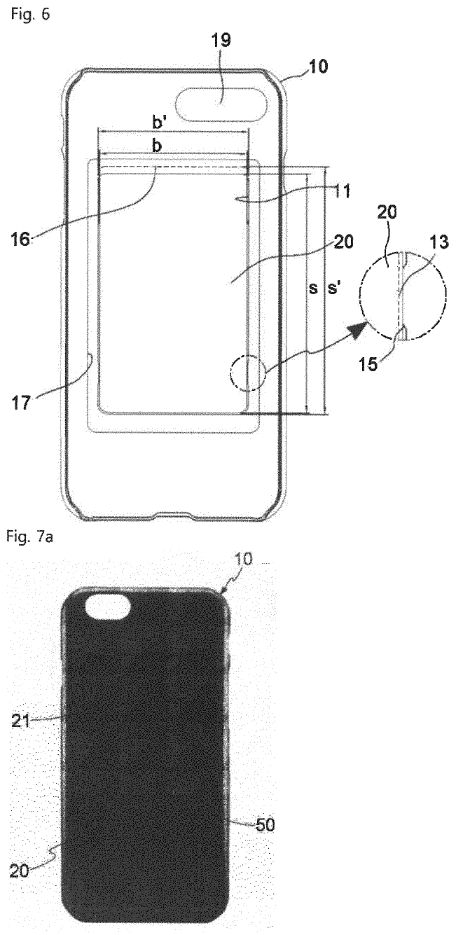

In addition, projections 15 are formed to protrude oppositely from the lower portions of the respective rails 13, as shown in FIG. 6, such that when the card 20 is inserted to be guided along the rails 13, the both side surfaces of the card 20 pass through the protrusions 15 and then a click sound is generated so as to be audibly recognized when the storage is completed. At the same time, the protrusions 15 support the side surfaces of the card 20 tightly such that the card 20 stored in the mobile phone case 10 does not fall out while the mobile phone is carried.

Herein, FIG. 6 shows that an inclined surface is formed to allow the card 20 passes through the protrusions 15 stably when storing the card 20 according to an embodiment of the present invention, wherein it could be understood that a plurality of the protrusions may be installed into a hemispherical shape on the rails 13.

In addition, the inclined surface 16 is formed on the upper portion of the extension part 12 such that the upper portion of the card 20 inserted along the rails 13 is placed obliquely thereon, wherein if the card 20 is stored along the rails 13 through the extension part 12, the upper portion of the card 20 is placed obliquely on the inclined surface 16, as shown in FIG. 5.

Accordingly, when withdrawing the card 20, if the user holds the mobile phone case 10 with one hand and pushes the card 20 upwards with the thumb, the card 20 can be easily pulled out of the rails 13 since the upper portion of the card 20 is lifted upwards, that is, in the withdrawal direction of the card 20 by the inclined surface 16, A rectangular concave groove 17 is formed on the inner surface of the mobile phone case 10 so as to be positioned outside the opening part 11, such that an electromagnetic wave shield member 30 is adhesively fixed to the inside of the rectangular concave groove 17.

At this time, if the electromagnetic wave shield member 30 is formed of a soft material, the magnet 22, on which the card information is recorded, can be prevented from being damaged by the friction with the electromagnetic wave blocking member 30 when storing or withdrawing card 20 on rail 13 via extension part 12 and, at the same time, since the electromagnetic wave shield member 30 is completely closed on the rear surface of the mobile phone 40, scratches of the magnet 22 can be prevented from occurring due to the friction caused by the storing or withdrawing of the card 20.

In addition, it is more preferable that the electromagnetic waves shield member 30 is formed of a transparent material so as to express a variety of pictures, patterns, characters, and the like on the surface thereof to be connected to the rear surface of the mobile phone, since such an appearance can appeal to the sensitive young people in design.

First, if the mobile phone 40 is encased while the electromagnetic wave shield member 30 is adhesively fixed to the rectangular concave groove 17 formed on the inner surface of the mobile phone case 10 of the present invention, the liquid crystal panel positioned on the front of the mobile phone 40 is exposed to the outside and various function buttons and the camera of the mobile phone 40 are exposed to the outside through the openings 18, 19 so as to enable the manipulation of the mobile phone 40.

At this time, since the liquid crystal panel and the buttons of the mobile phone 40 as well as the camera are encased in the mobile phone case 10 and the opening part 11 formed in the rear surface of the mobile phone case 10 is closed by the electromagnetic wave shield member 30, the mobile phone is protected from external shock.

In a state, in which the mobile phone case 10 surrounds the mobile phone 40 as described above, if the lower part of the card 20 is pushed into the lower portion of the mobile phone case 10 through the extension part 12 positioned at the upper portion of the opening part 11 formed in the rear surface of the mobile phone case 10, then the both side edges of the card 20 are guided and inserted stably along the rails 13, as shown in FIG. 5, wherein since the protrusions 15 are oppositely formed at both sides of the lower portions of the rails 13, if the card 20 is pushed strongly to pass through the protrusions 1, a click sound is generated at the time when the card 20 is completely stored such that the user can audibly recognize that the insertion of the card 20 is completed without visually confirming whether the insertion of the card 20 is completed.

If the card 20 is stored along the rails 13 through the extension part 12 by the above mentioned procedure, since the height s of the opening part 11 is formed to be lower than the height s′ of the card 20, the upper portion of the card 20 is placed obliquely on the inclined surface 16 as shown in FIG. 5 and completely closes the opening part 11 such that the card 20 also serves as a part of the mobile phone case 10.

Herein, since the magnet 22 formed on the rear surface of the card 20 and storing the card information is stored in the opening part 11 while being connected to the electromagnetic wave shield member 30 made of a soft material, the magnet is prevented from being damaged and the both side surfaces of the card 20 are tightly connected to the protrusions 15 such that the card 20 is prevented from falling out of the mobile phone case 10.

Since the card 20 completely closes the opening part 11 in the state where the card 20 is stored in the mobile phone case 10 as described above, the mobile phone 40 is prevented from scratches or impacts.

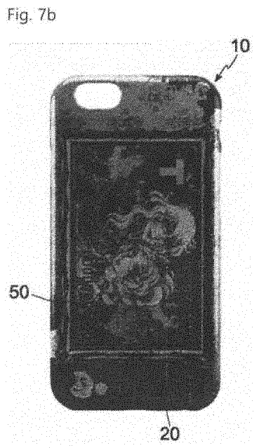

According to the present invention, the card 20 is exposed to the outside while the card 20 is stored in the mobile phone case 10. Therefore, there is an advantage that the characters or patterns formed on the surface of the card 20 can be continuously expressed to the surface of the mobile phone case 10, as shown in FIG. 7a and FIG. 7b such that it is also possible to expect an effect that sensitive young people can recognize mobile phones as small ornaments even without attaching a separate sticker (not shown).

Meanwhile, in the state where the card 20 is stored in the mobile phone case 10 as described above, the height t of the protrusion parts 14 constituting the rails 13 is formed to be higher than the height of the embossing 21 formed on the surface of the card 20, such that even if a frictional force is applied to the rear surface of the mobile phone case 10 in the process of repeatedly using the mobile phone on a desk or the like, the embossing 21 does not come into contact with the surface of the desk or the like and is thus prevented from being damaged.

When the user wants to take out the card 20, as necessary, from the mobile phone case 10 which the user carries, the card 20 is easily withdrawn from the opening part 11 by simply pushing the rear surface of the card 20 with the thumb of the hand holding the mobile phone case 10 while holding the mobile phone case 10 with one hand.

That is, if the user pushes the rear surface of the card 20 upwards with the thumb of the hand holding the mobile phone case 10 while holding the mobile phone case 10 with one hand, then the card 201, of which the upper portion is obliquely placed on the inclined surface 16 as shown in FIG. 5, comes out smoothly as indicated by a dashed line. Therefore, unlike the conventional mobile phone case from which a user has to draw a card by using both hands, the present invention enables the card 20 stored in the mobile phone case 10 to be conveniently and easily withdrawn with only one hand.

Meanwhile, according to the present invention, the electromagnetic wave shield member 30 is adhered and fixed to the rectangular concave groove 17 formed on the rear surface of the mobile phone case 10 such that, in the state where the transport pass 20 is stored in the mobile phone case 10 through the extension part 12, even if the user uses the transport pass for paying without taking out the transport pass from the mobile phone case 10, the electromagnetic waves generated by the mobile phone 40 are blocked by the electromagnetic wave shield member 30 and no errors are generated. Therefore, there is no need to remove the transport pass from the mobile phone case 10 when using the transport pass.

As described above, although the embodiments of the present invention have been described above with reference to the accompanying drawings, it will be understood by those of ordinary skill in the art, to which the present invention belongs, that the present invention may be embodied in other specific forms without departing from the spirit or essential characteristics thereof.

Therefore, the embodiments described above are to be understood as being in all respects illustrative and not restrictive, the scope of the present invention described in the foregoing description is defined by the appended claims, and all changes or modifications derived from the meaning and scope of the claims and their equivalents should be interpreted as being included in the scope of the present invention.

### BRIEF EXPLANATION OF REFERENCE SYMBOLS

| | |
|---|---|
| 10: Mobile phone case | 11: Opening part |
| 12: Extension part | 13: Rail |
| 14: Protrusion part | 15: Protrusion |
| 16: Inclined surface | |
| 17: Rectangular concave groove | |
| 20: Card | 21: Embossing |
| 30: electromagnetic wave shield member | |
| 40: Mobile phone | |
| b: Card width | b′: Width of extension part |
| s: Height of opening part | s′: Height of card |
| t: Height of protrusion part | |

What is claimed is:

1. A mobile phone case, comprising:
an opening part (11) formed in the rear surface of a mobile phone case (10) and having a size smaller than the total height (s′) of a card (20);
an extension part (12) formed at an upper portion of the opening part (11) and having a width that allows the card (20) to be inserted;
protrusion parts (14) formed at a lower portion of the extension part (12) so that rails (13) for accommodating both side edges of the card (20) is formed; and
an inclined surface (16) formed at an upper portion of the extension part (12) so that the upper portion of the card (20) inserted along the rails (13) is laid at a slant on the inclined surface (16),
wherein if the card (20) is inserted along the rails (13) through the extension part (12), the upper portion of the card (20) is laid at a slant onto the inclined surface (16) and the card (20) is accommodated in the opening part (11) and the inclined surface (16) so as to completely close the opening part (11).

2. A mobile phone case according to claim 1, wherein a rectangular concave groove (17) is formed on the inner surface of the mobile phone case (10) so as to be positioned at the outside of the opening part (11) and an electromagnetic wave shield member (30) is fixed to the inside of the rectangular concave groove (17).

3. A mobile phone case according to claim 1, wherein protrusions (15) are formed to protrude from the lower portions of the respective rails (13) so that the protrusions 15 tightly support the side surfaces of the card (20).
